(19) United States
(12) Patent Application Publication
(10) Pub. No.: US 2002/0133102 A1
(43) Pub. Date: Sep. 19, 2002

(54) Vibrator/massager with sound recording and playback features

(76) Inventor: Tricia D. Quan, Hermosa Beach, CA (US)

Correspondence Address: CISLO & THOMAS, LLP, 233 WILSHIRE BLVD, SUITE 900, SANTA MONICA, CA, 90401-1211, US

(21) Appl. No.: 09/810,146

(22) Filed: Mar. 15, 2001

(51) Int. Cl. A61H 1/00

(52) U.S. Cl. 601/46; 601/47

(57) ABSTRACT

A vibrator/massager with sound recording and playback features provides tactile as well as audio stimulation. A massaging or vibrating portion of the present invention may provide vibrating or massaging action. Power can be supplied by AC power or DC battery power to the vibrator and to the sound recording unit. The sound recording unit may provide both recording and playback features or, in some embodiments, just playback features. A microcontroller with available memory or another sound signal recording reservoir may receive audio signals from a microphone. Upon recording noises, sounds, or the like, the microchip controller may then play those signals back through a speaker. The microchip controller may have a record button, a play button and an LED light. Materials used in the present invention should be such as to provide a safe operation with little or no risk of shock to the user.

### BACKGROUND OF THE INVENTION

1. Field of the Invention

This invention relates to massagers, vibrators, or the like, and more particularly to a vibrating massager that records and plays back audio signals.

2. Description of the Related Art

Vibrating massagers are known in the art and are generally used in conjunction with health, medical, or related activities. Personal massagers are also known in the art that act as sexual aids or toys, enabling or enhancing sexual experience.

Sound recording is also known in the art and has become a well-developed area of electronic and electrical engineering research.

Particularly with respect to sexual activities, a vibrator or massager that both records and plays back audio signals might be advantageously used to enhance sexual activities or act as an erotic, romantic gift.

However, the art has not been developed in this area and no such vibrating massager with audio recording and playback is known in the art. Additionally, a review of the prior art indicates that no motivation or disclosure has previously been established setting forth the achievement of such a vibrating massager.

U.S. Pat. No. 5,163,447 issued to Lyons on Nov. 17, 1992 for a Force-Sensitive, Sound Playing Condom. Referring to FIGS. 1 and 2, the disclosed condom includes within a rim extension 18 a piezoelectric sound transducer 22, a microchip 24, and battery 26. Force-sensitive switching is provided such that the microchip 24 is energized at appropriate times to control actuation of piezoelectric sound transducer 22. A pre-recorded musical piece or voice message is then generated by sound transducer 22 as actuated by microchip 24. No provision is made for enabling a recording operation during use of the disclosed device or for actuating any vibration.

U.S. Pat. No. 4,175,552 issued to Johnson on Nov. 27, 1979 for a Vibration Device designed for massaging the user's body. Referring to FIG. 1, the vibrating device 10 simply incorporates speaker means within a housing 16. The vibration of the speaker means when driven to a record player 26, a tape player 28, or a radio/television set 30, imparts a vibration to housing 16 while emitting reproduced sound. No provision is made within the vibrating housing 16 for any form of sound recording.

U.S. Pat. No. 5,468,172 issued to Basile on Nov. 21, 1995 for a Doll Including Recorded Message Means. The doll is equipped with sound recording and playback devices, along with a mechanical movement-generating mechanism. Referring to FIG. 3, the disclosed doll is formed with a recorder 35 coupled to a microphone 50 and a speaker 40. It is also formed with motor-driven gears 58, 61 for automatically moving, for instance, the doll's arms. During use, the doll is capable of recording and playing back the user's voice while carrying out automatic hand, leg, or other movements.

U.S. Pat. No. 3,137,092 issued to Salerno on Jun. 16, 1964 for a Mechanism for Simulating Sounds and Vibrations of a Heart Beat which is intended generally to comfort and pacify infants and children. The device may be incorporated into, among other things, a doll, as shown in FIG. 7.

U.S. Pat. No. Re. 35,082 reissued to Kuo on Nov. 7, 1995 for a Vibrating and Sonic Device for Toy Gun discloses a device equipped with means for generating both shaking, sound, and/or lighting effects. Referring to FIGS. 1 and 2, the toy gun includes a sound-generating circuit 4 and a megaphone 5 adapted to generate gun-firing sounds. The toy gun also includes a motor-driven cam 3 that rotates to transmit a vibrational force to the hollow barrel portion of the gun.

U.S. Pat. No. 5,063,912 issued to Hughes on Nov. 12, 1991 for a Sleep Inducing Device is intended for use with young infants. Essentially, this disclosed device packages within a pillow-like foam covering 112 a sound reproducing mechanism that reproduces sounds normally occurring in a mother's womb.

U.S. Pat. No. 5,165,814 issued to Buda on Nov. 24, 1992 for a Vibration Writing Instrument provides a device equipped with a vibrating relay to generate a massaging vibration during its use.

Consequently, it remains to be seen and developed in the art that a vibrating massager can be established that provides vibrating massaging as well as sound recording and playback.

### SUMMARY OF THE INVENTION

The present invention provides a vibrator/massager with sound recording and playback features. A vibrator that may be a vibrator known in the art is coupled to a sound recording and playback apparatus that may have an adjustable volume. The vibrator may take a probe-like configuration while the audio recording and playback unit may be a microphone and a speaker coupled to a microchip or the like capable of storing pre-recordings and contemporaneous sound signals on the order of a few seconds to several minutes. The power source for the audio recording/playback unit may be the same as that for the vibrating massager and may be supplied by AC power or DC battery power.

The entire device may be self-contained such that the audio playback and recording unit forms an integral and unobtrusive part of the vibrating massager. While the volume level may be preset, in an alternative embodiment, the volume of the playback signal may be adjustable through a turnable knob or the like.

### OBJECTS OF THE INVENTION

It is an object of the present invention to provide a vibrating massager that both records and plays back audio signals.

It is yet another object of the present invention to provide a vibrating massager that incorporates audio recording and playback that is self-contained.

It is yet another object of the present invention to provide a vibrator/massager that uses a microchip to provide audio recording and playback.

It is an additional object of the present invention to provide an enhanced massaging experience by providing audio recording and playback.

These and other objects and advantages of the present invention will be apparent from a review of the following specification and accompanying drawings.

### BRIEF DESCRIPTION OF THE DRAWINGS

FIG. 1 is a perspective view of the vibrator/massager with the bottom of the housing removed to reveal the inner components of the preferred embodiment of the present invention.

FIG. 2 is an exploded view of the preferred embodiment of the present invention.

FIG. 3 is a side view of the preferred embodiment of the present invention.

### DESCRIPTION OF THE PREFERRED EMBODIMENT(S)

The detailed description set forth below in connection with the appended drawings is intended as a description of presently preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

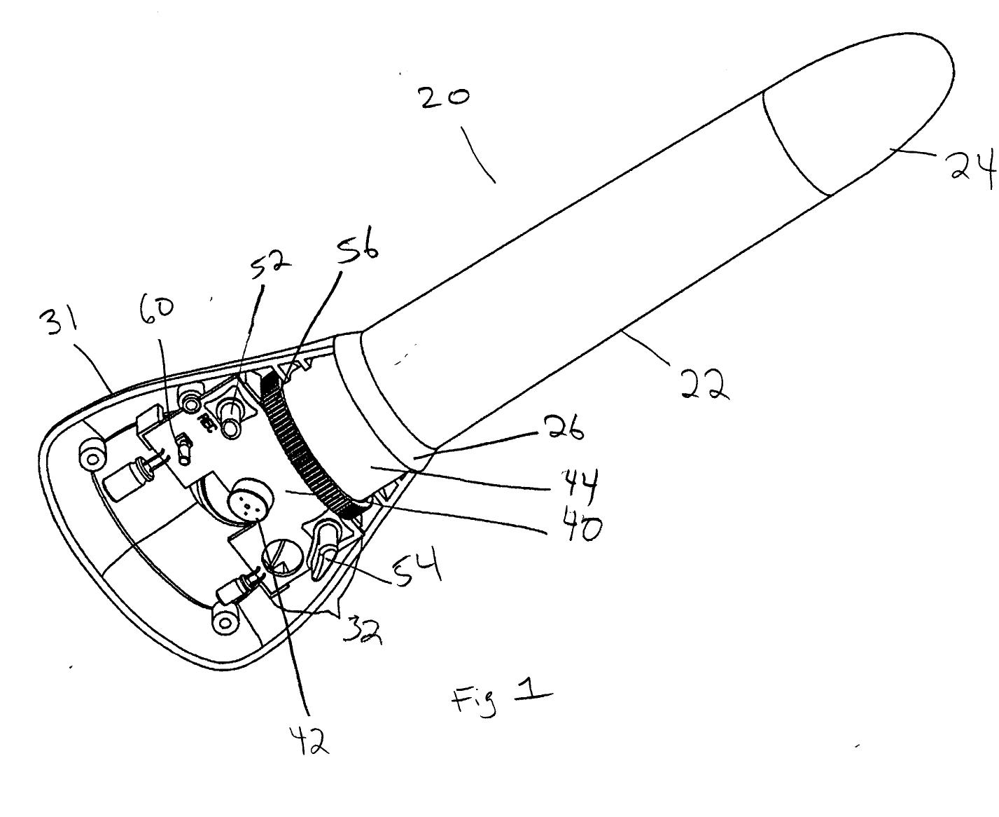

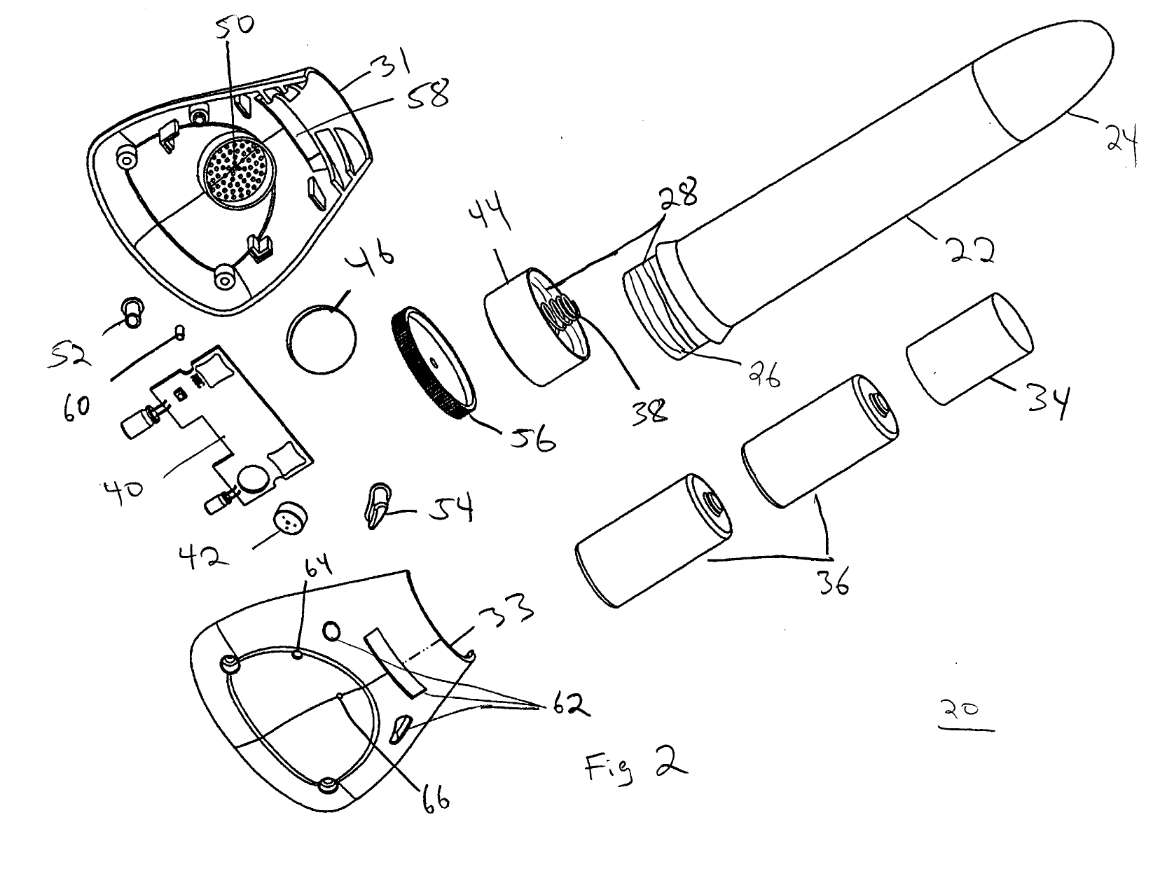

As shown in FIGS. 1 and 2, the vibrator/massager 20 with audio recording and playback of the present invention has a main body 22, which, in the embodiment shown, may have a probe-like configuration of approximately six (6) to ten (10) inches. The distal end 24 of the main body 22 is rounded with the sides of the main body 22 being generally cylindrical and straight. The main body 22 may be hollow and may incorporate an oscillating or eccentric motor 34 or the like to provide vibration when the vibrator 20 is switched on. Additionally, the hollow nature of the main body 22 may provide room for batteries 36 or the like so that power may be supplied to the vibrator 20. The base 26 of the main body allows for a cover 44, which has a metal spring 38 allowing the negative (−) end of the batteries 36 to contact. The cover 44 and the base 26 may contain threading 28 to allow for easy attachment and removal of the cover 44 as well as in order to prevent the interchanging of parts. In this way, the vibrator 20 of the present invention prevents mismatching of parts, which could possibly cause a hazardous condition.

Underneath the cover 44, a speed control apparatus 56 attaches, yet still allows for rotational movement. The speed control apparatus 56 has the ability to slow or quicken the pace of the oscillating or eccentric motor 34 by rotating the speed control apparatus 56 in a clockwise or counter-clockwise motion. The base 26 of the main body 22 is generally round in nature allowing the top half 31 of the housing 30 to snap-fit to the bottom half 33 of the housing 30 around the base 26. Generally, any method of connecting the top half 31 of the housing 30 to the bottom half 33 of the housing 30 around the base 26 can be used.

The housing 30 may form an area to which the audio playback and recording mechanism 32 may be attached, affixed, or associated with the vibrator/massager 20 of the present invention. As shown in FIG. 1, the audio playback and recording unit 32 has a controller 40 which serves to provide storage and control to the audio playback unit, controlling both the recording and playback means. The controller 40 may be a microchip or microprocessor unit. A microphone 42 may provide the necessary recording means and a speaker 46 may provide the necessary playback means. The microphone 42 and speaker 46 are electrically connected to the controller 40. Recording activation means 52 and playback activation means 54 may be present by way of a plurality of buttons, but may exist by other means such as voice activation. The top half 31 of the housing 30 may have perforations 50 in order to improve the clarity and loudness of the audio from the speaker 46 as well as an elongated opening 58 allowing the user to access the speed control apparatus 56. The bottom half 33 of the housing 30 may have a plurality of openings 62 allowing the user to access the recording activation means 52, the playback activation means 54 and the speed control apparatus 56. Also, the bottom half 33 of the housing 30 may have an opening 64 allowing the user to view an LED light 60 and an opening 66 to improve the clarity and loudness of the audio to the microphone 42.

Additionally, pre-recorded microchips may be included or associated with a microchip, microprocessor unit or controller 40. Such pre-recorded microchips may contain pre-recorded audio signals such as those of celebrity porn or erotica stars and the like in order to enhance the sexual and/or massaging experience delivered by the massager 20 of the present invention. Such additional pre-recorded microchips may be interchangeable so that a variety of pre-recorded audio signal sets can be delivered by the vibrator 20 of the present invention.

In order to operate the vibrator/massager with sound recording and playback 20 of the present invention, the unit is vibrating and it may be switched on separately from the sound recording/playback unit 32. In the following example, the sound recording and playback operation is assumed to be done while the vibrator portion of the present invention 20 is off. It can be anticipated that while some acoustic isolation might be achieved so that sound recording could take place while the vibrator portion was on, generally this might be to some acoustical interference with another intended signal for the sound recorder/playback unit 32.

When the individual or individuals are ready to record audio signal on the sound recorder/playback unit 32, the recording activation means 52 is pressed or the recording activity is otherwise activated. The microchip/controller 40 then begins storing the audio signal impressed upon it by the microphone 42 through the perforations 50. During this time, the LED light 60 is activated and deactivated when recording has been completed. Although, it would not be necessary for the LED light 60 to function in this way. It can indicate battery power, playback, recording or not have a function at all. The sound is recorded by the microchip controller 40 until either the recording activation means 52 is pressed again, the recording process is otherwise deactivated, or the microchip controller 40 runs out of available sound recording memory or space. Alternatively, the microchip controller 40 may continuously record a signal until the recording process is deactivated (as by pressing the recording activation means 52 again). Under such circumstance, the microchip controller 40 would overwrite either a free space in its sound storage reservoir of memory or space or the oldest recorded signals.

Once the recording process is complete, the vibrator portion as exemplified by the main body 22 may be activated and the sound may be played back through the speaker 46 by pressing the playback activation means 54 otherwise activating the sound playback process. Other embodiments maybe possible to combine certain features of this invention such as providing a single unit that acts as a microphone and a speaker.

The vibrator/massager with sound recording and playback device 20 of the present invention may be made of durable materials, preferably those that withstand wet or moist environments as well as being electrically safe and secure without delivering a risk of shock to the user.

In alternative embodiments, certain desirable sound recordings may be delivered or provided to the vibrator/massager 20 of the present invention by providing a read-only memory chip or the like. Under such circumstances, it may be possible to eliminate the recording feature of the present invention and just to provide the playback of desired or preferable sounds. In this embodiment, the audio recording and playback unit 32 acts as a audio playing unit, the playback means 46 acts as a playing means and the playback activation means 54 acts as a playing activation means.

Power may be supplied either by batteries or by adapted AC power for the vibrator 20 of the present invention. Battery power generally delivers more portability to the vibrator 20. However, AC power may deliver longer and more continuous use of the vibrator 20 without the depletion suffered by batteries.

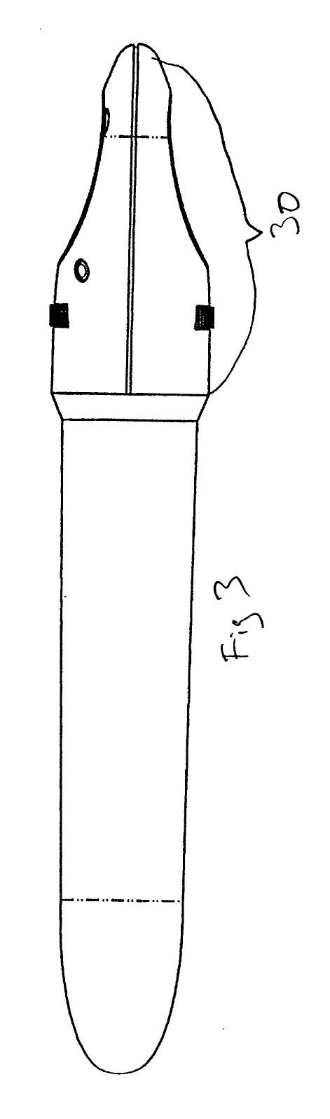

FIG. 3 shows a side view of the present invention illustrating the contoured shape of the housing 30. However, the housing 30 may take other shapes.

While the present invention has been described with regards to particular embodiments, it is recognized that additional variations of the present invention may be devised without departing from the inventive concept.

What is claimed is:

1. A vibrator/massager comprising:
a. a distal end;
b. a main body, having a distal end and a base,
c. a base;
d. a housing, said housing having a top and a bottom;
said housing attaching to said base, said housing having an audio playback and recording unit; whereby a vibrator/massager with sound recording and playback may be provided for enhanced massaging activity.

2. A vibrator/massager as described in claim 1, wherein:
said audio playback and recording unit comprising a controller, recording means, playback means, recording activation means, playback activation means, said recording means, said playback means, said recording activation means and said playback activation means electrically connected to said controller.

3. A vibrator/massager as described in claim 2,wherein:
said main body having an oscillating or eccentric motor, said main body being hollow whereby providing room for batteries or the like to provide power.

4. A vibrator/massager as described in claim 3, wherein:
a cover attaching to said base, a speed control apparatus providing variations of speed of said oscillating motor attaching to said cover.

5. A vibrator/massager as described in claim 4, wherein:
said top of said housing and said bottom of said housing attaching together to cover said base, said cover and said speed control apparatus.

6. A vibrator/massager as described in claim 5, wherein:
said bottom and said top of said housing having a plurality of openings, said openings on said bottom of said housing allowing a user to access said speed control apparatus, said recording activation means, said playback activation means and said recording means,
said openings on said top of said housing allowing a user to access said speed control apparatus and said playback means.

7. A vibrator/massager as described in claim 6, wherein:
said openings on said top of said housing allowing a user to improve the clarity and loudness of said playback means in the form of perforations.

8. A vibrator/massager as described in claim 7, wherein:
DC battery power or adapted AC power coupled to and used for said oscillating or electric motor and said audio playback and recording unit.

9. A vibrator/massager as described in claim 8 wherein, said recording means is a microphone and said playback means is a speaker.

10. A vibrator/massager as described in claim 8, wherein a plurality of buttons represent said recording activation means and said playback activation means.

11. A vibrator/massager as described in claim 8, wherein an LED light electrically connected to said controller whereby said LED light activating when the recording feature of the device is active.

12. A vibrator/massager comprising:
a. a distal end;
b. a main body, having a distal end and a base,
c. a base;
d. a housing, said housing having a top and a bottom;
said housing attaching to said base, said housing having an audio playing unit;
whereby a vibrator/massager with sound playing features may be provided for enhancing massaging activity.

13. A vibrator/massager as described in claim 12, wherein:
said audio play unit comprising a controller, playing means, and a playing activation means, said playing means and said playing activation means electrically connected to said controller.

14. A vibrator/massager as described in claim 13, wherein:
said main body having an oscillating or eccentric motor, said main body being hollow whereby providing room for batteries or the like to provide power.

15. A vibrator/massager as described in claim 14, wherein:
a cover attaching to said base, a speed control apparatus providing variations of speed of said oscillating or eccentric motor attaching to said cover.

16. A vibrator/massager as described in claim 15, wherein:
said top of said housing and said bottom of said housing attaching together to cover said base, said cover and said speed control apparatus.

17. A vibrator/massager as described in claim 16, wherein:
said bottom and said top of said housing having a plurality of openings, said plurality of openings on said bottom of said housing allowing a user to access said speed control apparatus and said playing activation means,
said plurality of openings on said top of said housing allowing a user to access said speed control apparatus and said playing means.

18. A vibrator/massager as described in claim 17, wherein:
said plurality of openings on said top of said housing allowing a user to improve the clarity and loudness of said playing means in the form of perforations.

19. A vibrator/massager as described in claim 18, wherein:
DC battery or adapted AC power coupled to and used for said oscillating or eccentric motor and said audio playing unit.

20. A vibrator/massager as described in claim 19 wherein, said playing means is a speaker.

21. A vibrator/massager as described in claim 19, wherein a button represents said playing activation means.

22. A vibrator/massager as described in claim 19, wherein an LED light electrically connected to said controller whereby said LED light activating when the playing feature of the device is active.

23. A vibrator/massager comprising:
a distal end;
a main body, having a distal end and a base;
a base;
a housing, said housing having a top and a bottom;
said housing attaching to said base, said housing having an audio playback and recording unit,
said audio playback and recording unit comprising a controller, recording means, playback means, recording activation means, playback activation means, said recording means, said playback means, said recording activation means and said playback activation means electrically connected to said controller;
said main body having an oscillating or eccentric motor, said main body being hollow;
a cover attaching to said base, a speed control apparatus attaching to said cover;
said top of said housing and said bottom of said housing attaching together to cover said base, said cover and said speed control apparatus;
said bottom and said top of said housing having a plurality of openings, said openings on said bottom of said housing allowing a user to access said speed control apparatus, said recording activation means, said playback activation means and said recording means, said openings on said top of said housing allowing a user to access said speed control apparatus and said playback means;
said openings on said top of said housing allowing a user to improve the clarity and loudness of said playback means in the form of perforations;
DC battery power or adapted AC power coupled to and used for said oscillating or eccentric motor and said audio playback and recording unit;
a plurality of buttons representing said recording activation means and said playback activation means;
an LED light electrically connected to said controller whereby said LED light activating when the recording feature of the device is active; whereby a vibrator/massager with sound recording and playback may be provided for enhanced massaging activity.
